(19) United States
(12) Patent Application Publication
(10) Pub. No.: US 2003/0235118 A1
(43) Pub. Date: Dec. 25, 2003

(54) Clock assembly with movable ornaments

(76) Inventor: Hsin-Chiung Lai, Taipei Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/176,862

(22) Filed: Jun. 20, 2002

(51) Int. Cl. G04C 17/00; G04B 25/00; G04B 19/00

(52) U.S. Cl. 368/223

(57) ABSTRACT

A clock assembly has a body with a front and a rear surface, wherein the front surface is used as a clock dial face of the clock assembly, and a chamber is defined in the rear surface. A clock, a circuit board, a power supply box and at least one actuating device controlled by the circuit board are all retained in the chamber. At least one movable ornament is mounted on the clock dial face and controlled by the at least one actuating device to generate dynamic motions based on the signals from the circuit board. The movable ornament is able to generate dynamic actions on the hour to enhance the decorative effects of the entire clock assembly.

### BACKGROUND OF THE INVENTION

1. Field of Invention

The present invention relates to a clock assembly, and more particularly to a clock assembly provided with ornaments capable of motion, such as movable cartoon dolls, on the dial face of the clock assembly to enhance the decorative effects when the clock assembly tells the time on the hour.

2. Related Art

There are many different kinds of clocks available on the market. To provide the more variety of clocks, some clocks are installed with the ornamental elements to enhance the appearance of clocks. Another way to increase the variety of clocks is by the new particular design of clock shape or appearance. However, the decorations are fixed on the clock and appear dull. For consumers who are interested in novel things, these existing clocks are still not satisfactory.

To overcome the shortcomings, a clock assembly with movable ornaments in accordance with the present invention obviates or mitigates the aforementioned problems.

### SUMMARY OF THE INVENTION

The primary objective of the present invention is to provide a clock assembly with movable ornaments, wherein the ornaments mounted on the clock dial surface are able to generate dynamic actions on the hour to enhance the variety of the clock.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a clock assembly with movable ornaments in accordance with the present invention;

FIG. 2 is a rear plan view of the clock assembly of FIG. 1, wherein a rear cover is removed;

FIGS. 3A and 3B are schematic views of the movable ornaments showing the swinging motion; and

FIG. 4 is a front plan view of a second embodiment of the clock assembly, wherein twelve movable ornaments are disposed at the positions of figures on the dial face of the clock assembly.

### DETAILED DESCRIPTION OF THE INVENTION

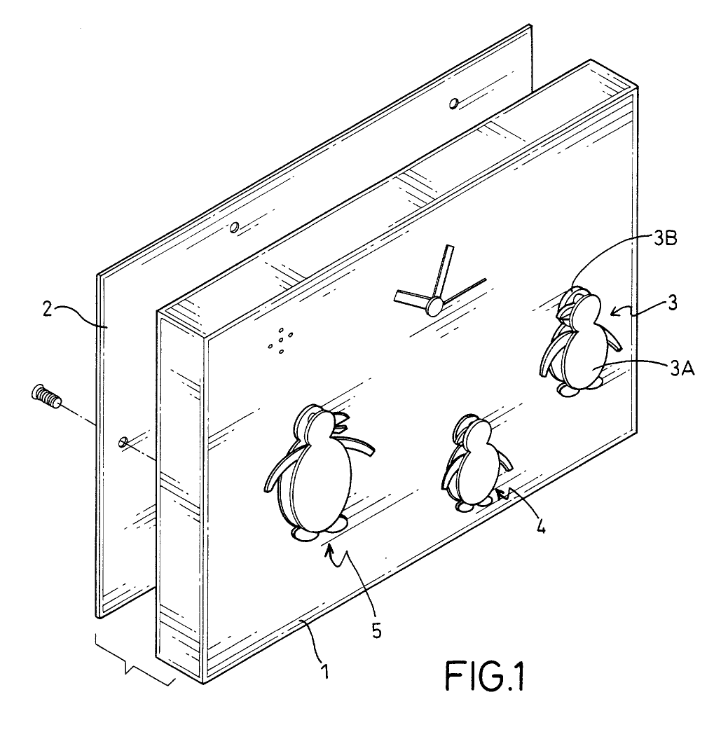

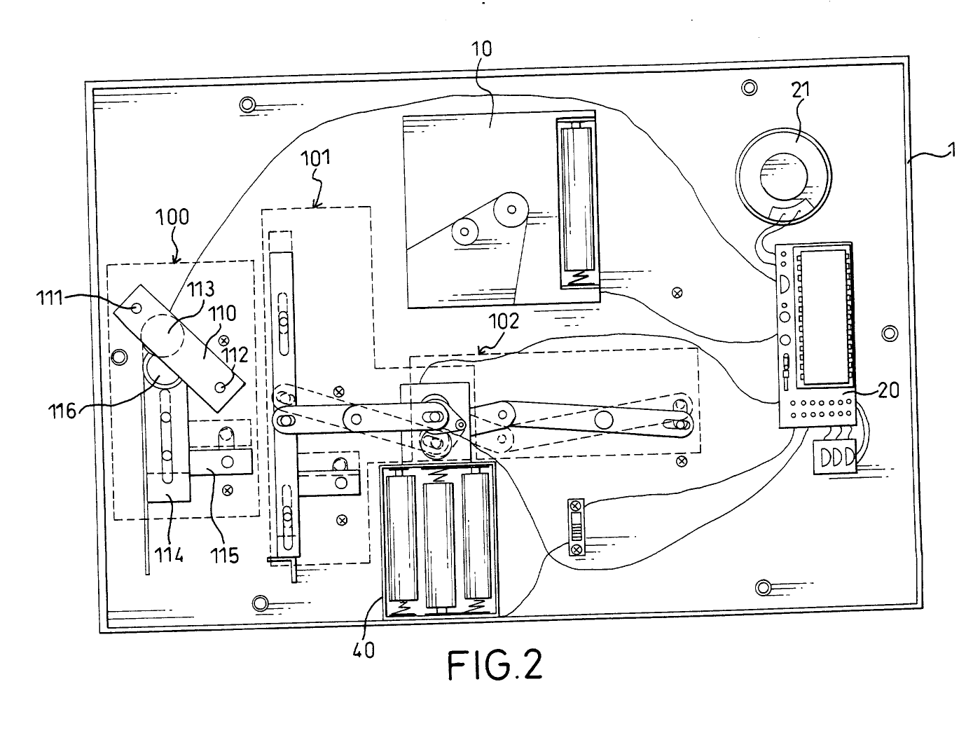

With reference to FIG. 1, a clock assembly in accordance with the present invention comprises a rectangular body (1) defined with a chamber (not numbered) at the back of the body (1), wherein a rear cover (2) is attached to seal the chamber. In the embodiment, there are three ornaments (3, 4 and 5) movably mounted on a front surface of the body (1). The actions of the ornaments (3, 4 and 5) are controlled by several sets of actuating devices (100-102) (shown in FIG. 2) disposed inside the chamber.

With reference to FIG. 2, a clock (10), a control circuit board (20) connected with a speaker (21), a power supply box (40) and the actuating devices (100, 101 and 102) are mounted and disposed on the bottom of the chamber. The power supply box (40) has batteries retained therein and provides power to the control circuit (20). The minute hand and hour hand of the clock (10) are disposed at the front surface of the body (1) (shown in FIG. 1), thus the front surface of the body (1) is used as a clock dial face of the clock assembly. The actuating devices (100, 101 and 102) may be varied in many different types. One example of the actuating devices (100, 101 and 102) utilizing the magnetic attraction and repulsion to drive the ornaments (3, 4 and 5) is preferably adopted and described hereinafter.

To more concisely explain the motion of the ornaments (3), only one actuating device (100) corresponding to the first ornament (3) is discussed because the moving principles of the other devices (101, 102) are similar to the first actuating device (100).

In FIG. 2, the actuating device (100) comprises a first strip (110), a lengthwise strip (114) and a lateral strip (115). The first strip (110) stands above the bottom of the chamber via two legs (111, 112) that are secured on the chamber, wherein a coil (113) is connected to the control circuit board (20) and securely mounted on the bottom of the first strip (110). The lengthwise strip (114) extending with the lateral strip (115) is movably mounted on the bottom of the chamber, wherein the lengthwise strip (114) has a magnet (116) attached thereon. When the control circuit board (20) outputs current to energize the coil (113), the coil (113) generates the magnetic force to attract the magnet (116), whereby the lengthwise strip (114) and the lateral strip (115) are commonly moved upward.

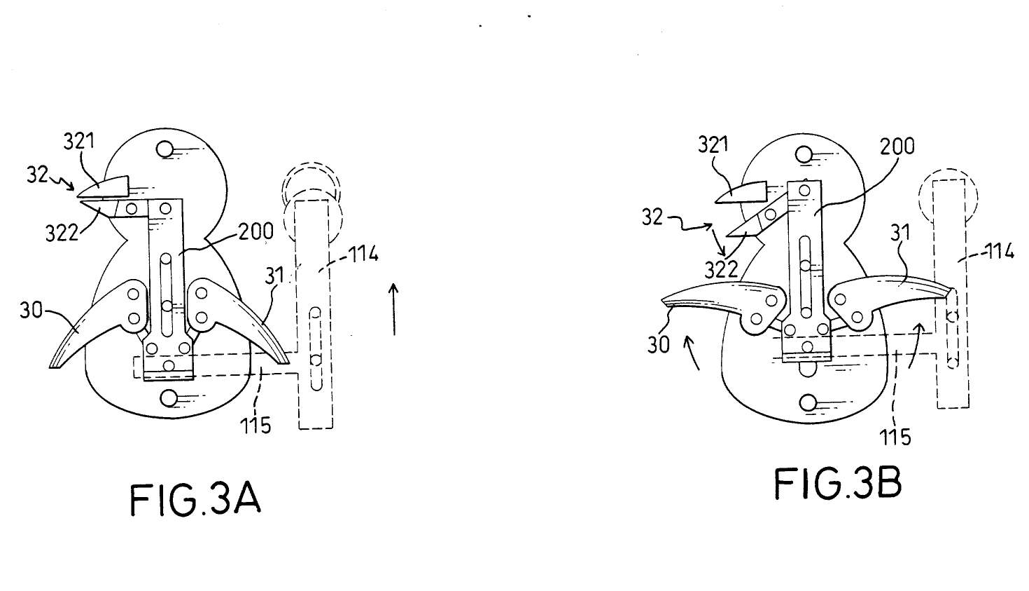

With reference to FIGS. 1 and 3A, the ornament (3) is formed as a penguin doll with an upper plate (3a) and a lower plate (3b), wherein FIG. 3A shows the upper plate (3a) is removed to show the driving structure sandwiched between the upper plate (3a) and the lower plate (3b). In FIG. 3A, the penguin ornament (3) has two movable wings (30, 31) and a mouth (32) that is made up of two plates (321) (322). A driving strip (200) is mounted on the ornament (3) and is movably connected with and controlled by the lateral strip (115). The two wings (31, 32) and the lower plate (322) of the mouth (32) are pivotally linked to the driving strip (200).

With reference to FIG. 3B, when the lateral strip (115) is moved upward by the magnetic attraction force, the driving strip (200) is consequently moved upward. Therefore, the two wings (30, 31) are swung upward and the lower plate (322) of the mouth (32) is swung downward, whereby the mouth (32) of the penguin ornament (3) is kept at the open state.

The dynamic motion of each ornament (3-5) is determined by the control signals output from the control circuit board (20). For example, when the control signals are properly output to energize the coil (113) on the hour, these penguin ornaments (3, 4 and 5) correspondingly swing their wings and open their mouths, meanwhile the speakers (21) output music to enhance the entire the decorative effects of the clock assembly.

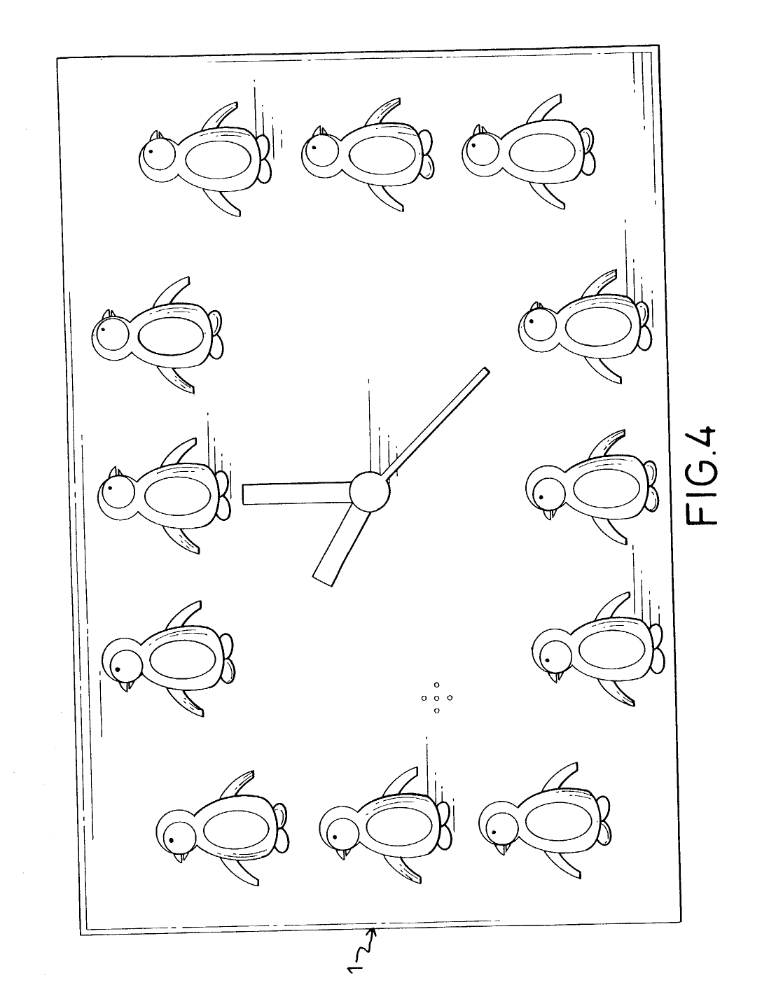

With reference to FIG. 4, twelve movable ornaments are disposed at the proper positions of the clock dial face. Each ornament represents as a number. These ornaments are able to be controlled to generate swing motion sequentially on the hour based on the signals from the control circuit board (20).

The invention may be varied in many ways by a skilled person in the art. Such variations are not to be regarded as a departure from the spirit and scope of the invention, and all such modifications are intended to be included within the scope of the following claims.

What is claimed is:

1. A clock assembly with movable ornaments, the clock assembly comprising:
a body having a front surface and a rear surface that is defined with a chamber, wherein a plate is applied to cover the chamber;
a clock disposed in the chamber, wherein a minute hand and a hour hand are disposed at the front surface of the body, whereby the front surface of the body is used as a clock dial surface of the clock assembly;
a control circuit board mounted in the chamber;
a power supply box mounted in the chamber to supply power to the control circuit board;
at least one actuating device mounted in the chamber and controlled by the control circuit board;
at least one movable ornament mounted on the front surface of the body and controlled by the at least one actuating device to generate motion when the control circuit board outputs signals to drive the at least one actuating device.

2. The clock assembly as claimed in claim 1, wherein the at least one movable ornament generates motions on the hour.

3. The clock assembly as claimed in claim 1, wherein a speaker is connected to the control circuit to output music.

4. The clock assembly as claimed in claim 2, wherein a speaker is connected to the control circuit to output music.

5. The clock assembly as claimed in claim 1, wherein the at least one actuating device utilizes magnetic force to control the movable ornament to move.

6. The clock assembly as claimed in claim 1, wherein twelve movable ornaments are disposed on the front surface of the body to represent as numbers of the clock assembly.
